(19) United States
(12) Patent Application Publication
(10) Pub. No.: US 2014/0369774 A1
(43) Pub. Date: Dec. 18, 2014

(54) Hollow Core Drive Shaft Device for Core Drilling and Method of Using the Same

(71) Applicant: Dan Matesic, Allison Park, PA (US)

(72) Inventor: Dan Matesic, Allison Park, PA (US)

(21) Appl. No.: 13/916,736

(22) Filed: Jun. 13, 2013

(51) Int. Cl. B23B 51/04

(52) U.S. Cl. CPC B23B 51/044; B23B 2270/54; B23B 2251/46
USPC 408/1 R; 408/67

(57) ABSTRACT

The present invention provides a device and method for independently anchoring a core in a core drilling operation prior to, during and after the drilling operation, so that upon severance of the core from its surrounding structure, free fall of the core is prevented and safety of nearby workers is protected. The device comprises a hollow core drive shaft and a structurally separate, independent anchoring device positioned within the central axis of the hollow core drive shaft and secured to the core. The device and method provides complete physical accessibility and visibility to the core at all times during a drilling operation. The core can thus be securely anchored from the top side of a structure without the need to brace the underneath side of the structure and having the core fall down upon severance from the structure.

### FIELD OF THE INVENTION

The invention relates to core drilling operations and, more particularly, to a device and method to anchor and secure a core in a core drilling device comprising a hollow core drive shaft and a completely separate and independent anchoring device configured for containment within the hollow core drive shaft which prevents release of the core from the core drilling device upon severance of the core from its surrounding structure.

### BACKGROUND OF THE INVENTION

Core drilling is performed using core drills attached to drill bits to remove a cylinder, or slab, of material from a structure. Core drills allow for the drilling operation to be done more rapidly and effectively, since only a certain diameter hole is drilled, which avoids pulverization of the surrounding material in order to drill the hole. The material severed from the drilled material inside the drill bit is referred to as the core. In concrete core drilling, vertical or horizontal holes are placed in the concrete slabs, with drill bits being variable in diameter and length depending on the needs of the drilling project.

The diameter of the core remaining in the core drill bit is dependent on the diameter of the core drill bit, and may range from as little as about one-half inch to several feet in diameter. The length of the core is dependent on the length of the core drill bit and/or the depth of the structure being drilled, i.e., a wall, floor, ceiling, and may also range from about one-half inch to several feet in length.

Thus, the resultant drilled core can be substantial in size and weight and may pose a danger to nearby workers, especially when drilling slabs that are elevated and/or horizontally aligned. This is because after cutting through the opposing side of the structure being drilled, the core, subjected to gravity, typically will fall out of the drill bit and fall down past the drilled structure, unless the core is somehow secured within the drill bit.

Currently, there are only a few ways in the core drilling industry to secure a core from falling upon its release from a drilled material. For example, a worker may be positioned below the core to catch the core, or a catching device can be used (see U.S. Pat. No. 7,621,352, which describes a catcher rod attached to a core drill). In all instances, however, current industry practice is lacking independent physical accessibility and visibility to the core itself from above the drilled structure at all times during a drilling operation, in order to prevent free-fall of a core upon severance from its support and the concomitant danger to workers located near the falling core. This is because current core drilling devices lack the structural configuration to independently secure a core prior to, during, and after a drilling operation, due to standard core drills being effectively closed at one end, i.e., the end coupled to the core drill bit. This closure precludes physical accessibility and visibility of the core, so that independent securement of the core upon its release from the core drill bit is not possible.

There exists an important need, therefore, for a device and method which allows for independent anchoring of a core at all times during a drilling operation which overcomes the shortcomings and potential hazards of current industry equipment.

### SUMMARY OF THE INVENTION

The present invention fulfills this need by providing a device and method for independently anchoring a core prior to, during and after a core drilling operation, so that upon severance of the core from its surrounding structure, release of the core from a core drill bit is prevented.

In an aspect of the invention, there is provided a hollow core drive shaft device for independently anchoring a core in a drilling operation. The hollow core drive shaft device is comprised of a drill motor having a proximal end, a distal end and an interior space therein, wherein the drill motor is attached to a mounting carriage having a carriage travel gear thereon, wherein the mounting carriage has an interior space therein defining an opening, the opening containing a mounting post having a gear rack thereon, wherein the carriage travel gear is engaged with the gear rack to move the mounting carriage on the mounting post; a drill motor drive shaft having a proximal end, a distal end, and an interior space therein, the drill motor drive shaft contained within the drill motor, wherein the drill motor transfers power to the drill motor drive shaft in order to rotate the drill motor drive shaft; a hollow core drill bit having a proximal end, a distal end and an interior space defining an opening therein, the proximal end having a hollow core drill bit coupler thereon, wherein rotation of the drill motor drive shaft is transferred to the hollow core drill bit to rotate the hollow core drill bit, wherein the hollow core drive shaft device allows for physical accessibility and visibility to a portion of a slab prior to, during, and after drilling of the portion of the slab by the distal end of the hollow core drill bit to form a core contained within the hollow core drill bit; and an anchoring device having a proximal end and a distal end, the anchoring device completely separate from and independent of the mounting carriage and mounting post contained therein, the drill motor, the drill motor drive shaft, and the hollow core drill bit, the anchoring device located at least within the opening of the hollow core drill bit and having its distal end attached to the core, wherein attachment of the anchoring device to the core prevents release of the core from the hollow core drill bit upon severance of the core from surrounding slab.

In an embodiment, the interior space of the drill motor drive shaft contained within the drill motor defines an opening therein to form a hollow core drive shaft, the hollow core drive shaft threadably connected to the proximal end of the hollow core drill bit, and the anchoring device located within the opening of the hollow core drive shaft, as well as within the hollow core drill bit.

In another embodiment, the hollow core drive shaft device further comprises an attachment assembly. The attachment assembly is comprised of a gear box containing at least two gears, a drive shaft having an interior space defining an opening therein to form a hollow core drive shaft, and a drill motor mounting bracket. The first gear is a solid drive shaft gear and the second gear is a hollow core drive shaft gear. The drill motor is attached to the mounting bracket. The drill motor drive shaft threadably inserts into the solid drive shaft gear, the hollow core drive shaft threadably inserts into the hollow core drive shaft gear, and the hollow core drive shaft connects to the hollow core bit coupler of the hollow core drill bit. Power from the drill motor rotates the drill motor drive shaft which rotates the solid drive shaft gear, which rotation is transferred to the hollow drive shaft gear to rotate the hollow core drill bit. The independent anchoring device is located within the opening of the hollow core drive shaft gear, the hollow core drive shaft, and the hollow core drill bit, with its distal end securely attached to the portion of a slab to be drilled. Attachment of the anchoring device to the portion of the slab prevents release of the core from within the hollow core drill bit upon severance from surrounding slab.

When comprised of two gears, the solid drive shaft gear is adjacent to the hollow core drive shaft gear. When comprised of more than two gears, i.e., one or more intermediary gears, the one or more intermediary gears are positioned between the solid drive shaft gear and the hollow core drive shaft gear. Rotational movement of the solid drive shaft gear is transferred to the hollow core drive shaft gear via rotation of the intermediary gears.

In another aspect of the invention, there is provided a method of independently anchoring a core in a drilling operation. The method comprises placing an anchoring device through the opening of a hollow core drill motor, the hollow core drill motor attached to a mounting carriage having a mounting post contained therein, the opening of a hollow core drive shaft contained in the central axis of the hollow core drill motor, and the opening of a hollow core drill bit threadably connected to the hollow core drive shaft; attaching the anchoring device to a portion of a slab; and drilling the portion of the slab with the hollow core drill bit in order to sever the portion of the slab from surrounding slab to form a core, said core contained within the hollow core drill bit, wherein the anchoring device is completely separate from and independent of the mounting carriage and mounting post contained therein, the hollow core drill motor, the hollow core drive shaft contained in the hollow core drill motor, and the hollow core drill bit, and wherein no release of the core from within the hollow core drill bit occurs upon severance of the core from the surrounding slab.

In another aspect of the invention, there is provided a method of independently anchoring a core through a hollow core drive shaft device in a drilling operation. The method comprises attaching a drill motor drive shaft to an assembly attachment, the drill motor drive shaft having a proximal end and a distal end and contained within a drill motor, the drill motor attached to a mounting carriage containing a mounting post therein via an attachment bracket, the assembly attachment comprised of a gear box containing at least two gears, a hollow core drive shaft having an interior space defining an opening therein, a hollow core drill bit having a proximal end and a distal end and an interior space defining an opening therein, and a hollow core bit coupler having an interior space defining an opening therein, the hollow core bit coupler integral to and adjacent to the proximal end of the hollow core drill bit, wherein the at least two gears is a solid drive shaft gear and a hollow core drive shaft gear having an interior space defining an opening therein, wherein the drill motor drive shaft threadably inserts into the solid drive shaft gear, wherein the hollow core drive shaft threadably inserts into the hollow core drive shaft gear, wherein the hollow core drive shaft connects to the hollow core bit coupler of the hollow core drill bit, wherein power from the drill motor rotates the drill motor drive shaft which rotates the solid drive shaft gear, which rotation is transferred to the hollow core drive shaft gear to rotate the hollow core drill bit; placing an anchoring device through the openings of the hollow core drive shaft gear, the hollow core drive shaft, the hollow core bit coupler and the hollow core drill bit; attaching the anchoring device to a portion of a slab; and drilling the portion of the slab with the hollow core drill bit in order to sever the portion of the slab from surrounding slab to form a core, said core contained within the hollow core drill bit, wherein the anchoring device is completely separate from and independent of the mounting carriage containing a mounting post therein, the hollow core drive shaft gear, the hollow core drive shaft, the hollow core bit coupler and the hollow core drill bit, and wherein no release of the core from the hollow core drill bit occurs when the core is severed from the surrounding slab.

### BRIEF DESCRIPTION OF THE DRAWINGS

A fuller understanding of the invention can be gained from the following description when read in conjunction with the accompanying drawings in which:

FIG. 1 is an illustration of the hollow core drive shaft device comprised of an independent anchoring device placed within the opening of the hollow core drive shaft contained within the hollow core drive drill motor, and openings of the hollow core bit coupler and hollow core drill bit, the independent anchoring device attached to a portion of a slab to be drilled, according to the embodiments of the invention;

FIG. 2 is an illustration of an attachment assembly comprised of an independent anchoring device placed within the opening of the hollow core drive shaft gear, the hollow core drive shaft, the hollow core bit coupler and the hollow core drill bit, according to the embodiments of the invention;

FIG. 3 is an illustration of the hollow core drive shaft device and attachment assembly comprised of a standard drill motor attached to a mounting bracket, the solid drive shaft of the drill motor inserted into the solid drive shaft gear, and an independent anchoring device placed within the opening of the hollow core drive shaft gear, the hollow core drive shaft, the hollow core bit coupler and the hollow core drill bit, according to the embodiments of the invention;

FIG. 4 is an illustration of a three gear attachment assembly showing an independent anchoring device placed within the hollow core drive shaft gear, according to the embodiments of the invention;

FIG. 5 is an illustration of a three gear assembly attachment showing direction of rotational movement of each gear, according to the embodiments of the invention;

FIG. 6 is a cross-sectional illustration taken through point A-A of the hollow core drive shaft gear, according to the embodiments of the invention.

### DETAILED DESCRIPTION OF THE INVENTION

As used herein, the terms “anchor” and “secure” when used as verbs are meant to be interchangeable.

As used herein, the terms “anchoring device” and “anchor” when used as nouns are meant to be interchangeable.

As used herein, the terms “attachment” and “securement” are meant to be interchangeable.

As used herein, the terms “core,” and “severed core” are meant to be interchangeable.

As used herein, the terms “drill motor,” “drive motor” and “core drill” are meant to be interchangeable.

As used herein, the terms “hollow,” “hollow core,” “opening” and “central axis” are meant to be interchangeable.

As used herein, the terms “independent,” “isolated” and “separate” are meant to be interchangeable.

As used herein, the term “independent” is defined as not being structurally integral to the hollow core drive shaft device of the invention.

As used herein, the term “slab,” “substrate” and “structure” are meant to be interchangeable.

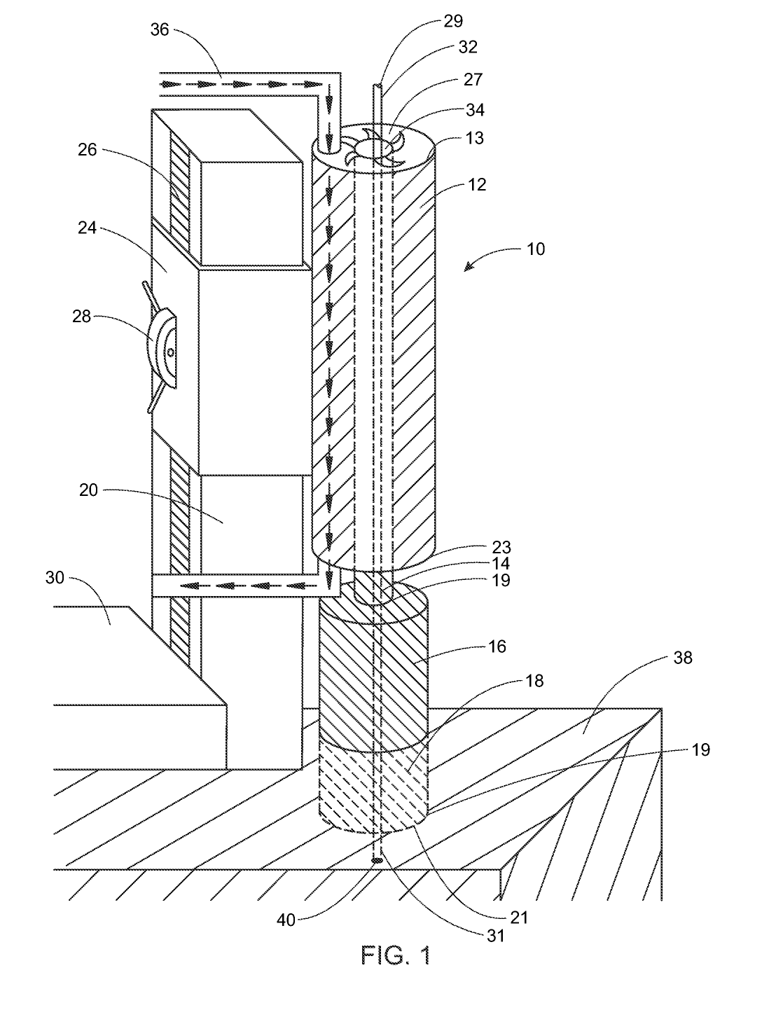

FIG. 1 shows an embodiment of the hollow core drive shaft device 10 having a hollow core drill motor 12, a hollow core drive shaft contained therein 14, a hollow core drill bit 16, and an anchoring device 32 having a proximal end 29 and a distal end 31. The hollow core drill motor 12 has a proximal end 13, a distal end 23, and an interior space. The hollow core drive shaft 14 is contained within the central axis of the interior space of the hollow core drill motor 12. At the proximal end 13 of the hollow core drive shaft are blades 34, e.g., a spiral gear, for rotating the hollow core drive shaft 14.

The hollow core drive shaft 14 is threadably connected to the proximal end 19 of the hollow core drill bit 16. Rotation of the hollow core drive shaft 14 rotates the hollow core drill bit 16. Arrows depict energy flow 36 for powering the hollow core drill motor. As shown in FIG. 1, energy 36 enters the proximal end 13 and exits the distal end 23 of the hollow core drill motor 12.

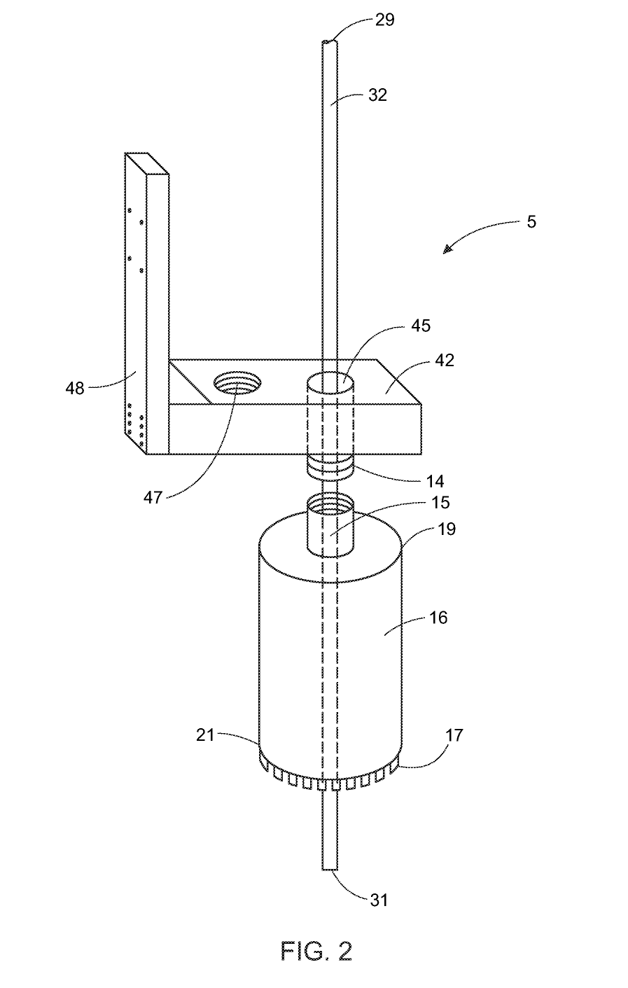

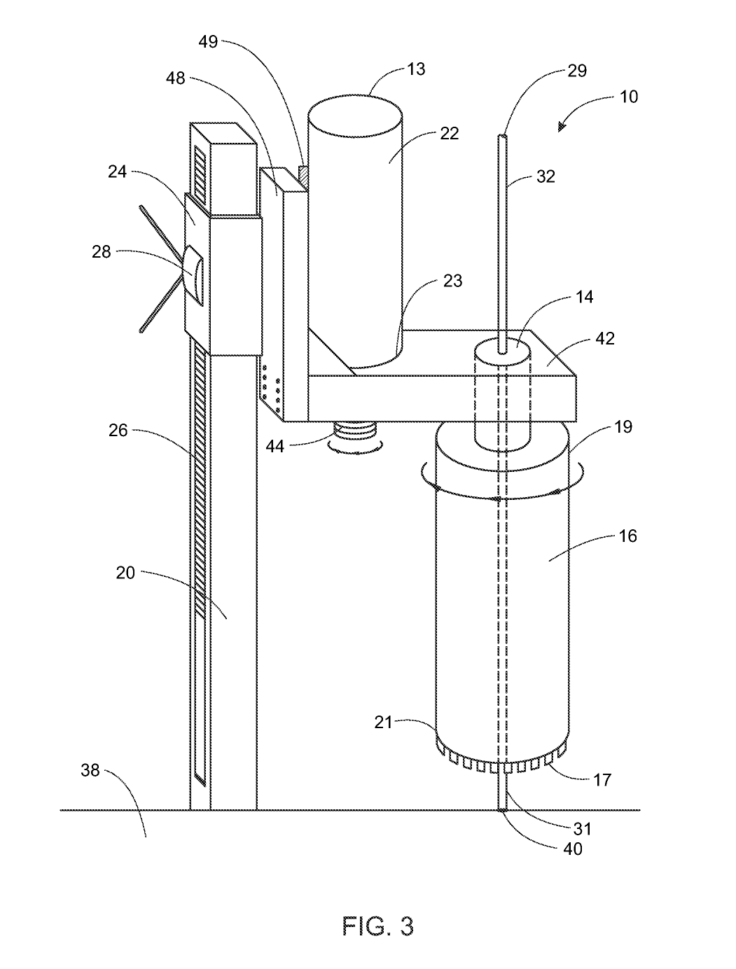

The anchoring device 32 is contained within the hollow core drive shaft 14 and the hollow core drill bit 16, but is physically separate from and independent of the hollow core drive shaft 14 and the hollow core drill bit 16. The distal end 31 of the anchoring device 32 is attached to a substrate (i.e., slab) 38 at an attachment point 40 to prevent release of a core 18 from within the hollow core drill bit 16 when severed from the surrounding slab 38 by the hollow core drill bit 16. In particular, the distal end 21 of the hollow core drill bit 16 is configured to drill through a slab 38 to form the core 18 which, when severed from the slab 38 by drilling completely through the slab 38 to its opposite end, is contained within the hollow core drill bit 16 and is prevented from falling down and away from within the hollow core drill bit 16 because of its attachment to the distal end 31 of the anchoring device 32. The proximal end 29 of the anchoring device 32 may be attached to any suitable attachment (not shown) to secure the anchoring device 32 from movement upon severance of the core 18 from surrounding slab 38. The distal end 21 of the hollow core drive shaft 16 may include a standard diamond tip cutting surface 17 commonly known and used in core drilling (shown in FIGS. 2 and 3).

The hollow core drive shaft device 10 in accordance with this embodiment allows for complete physical assessibility and visibility of the substrate 38 below through the hollow core drill motor 12 containing the hollow core drive shaft 14, and the hollow core drill bit 16, due to the opening, i.e., hollow core, through the entire central axis of the hollow core drive shaft device 10. This allows a user to be able to look down through the central axis of the hollow core drive shaft device 10 from the top all the way down to the substrate 38. This physical accessibility and visibility allows for easy securement of a portion of the substrate, i.e., the core 18, to the anchoring device 32 prior to a drilling operation, as well as for easy inspection of the core 18 at all times prior to, during, and after the drilling operation.

The hollow core drive shaft device 10 of the invention may be attached to any suitable structure commonly used by those skilled in the art for operating core drilling devices as well as for maintaining stability of the device during a drilling operation. A non-limiting example of such a structure is shown in FIG. 1, in which the hollow core drill motor 12 is attached by any suitable attachment known in the art, such as an attachment bracket (not shown), to a mounting carriage 24 having a carriage travel gear 28 thereon. The carriage travel gear 28 is engaged with a toothed gear rack 26 for moving the mounting carriage 24 on a mounting post 20. The mounting post 20 is affixed to a post base 30 which is secured to the slab 38. It should be appreciated, however, that whichever structure the hollow core drive shaft device of the invention is secured to in order to maintain stability, the anchoring device contained within the hollow core drive shaft device is completely separate, isolated and independent from the stability structure in all embodiments of the invention.

In operation, the distal end 31 of the anchoring device 32 is securely attached to the portion of a slab 38 to be drilled at an attachment point 40. Any suitable attachment means can be employed in accordance with the invention to securely attach the end of the anchoring device to the slab portion, such as, without limitation, through bolts, toggle bolts and the like. After securing the anchoring device 32 to the slab 38, the hollow core drill motor 12 is powered on and receives energy 36 which rotates the spiral gear 34 atop the hollow core drive shaft 14 which, in turn, rotates the hollow core drill bit 16. During rotation, the user manually pushes the hollow core drill bit 16 into the surface of the slab 38 by turning the carriage travel gear 28 located on the mounting carriage 24. The mounting carriage 24 and the hollow core drive shaft device 10 attached thereto moves down the mounting post 20, causing the hollow core drill bit 16 to penetrate the slab 38 and form a severed core 18 within the hollow core drill bit 16. The severed core 18 is prevented from falling away from within the hollow core drill bit 16 because of its securement to the distal end 31 of anchoring device 32.

In another embodiment of the hollow core drive shaft device of the invention, an attachment assembly is included, which is configured to attach to a standard drill motor containing a drive shaft therein to effectively convert the standard drill motor/drive shaft to the hollow core drill motor and hollow core drive shaft described above for independent anchoring of a core through the central axis of the hollow core drive shaft.

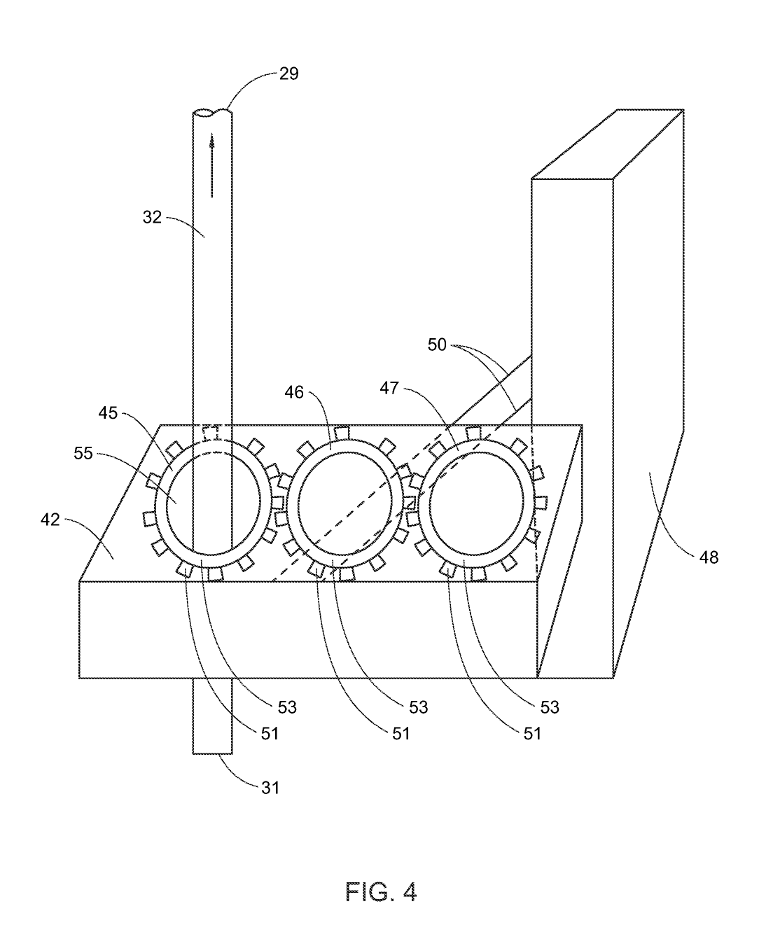

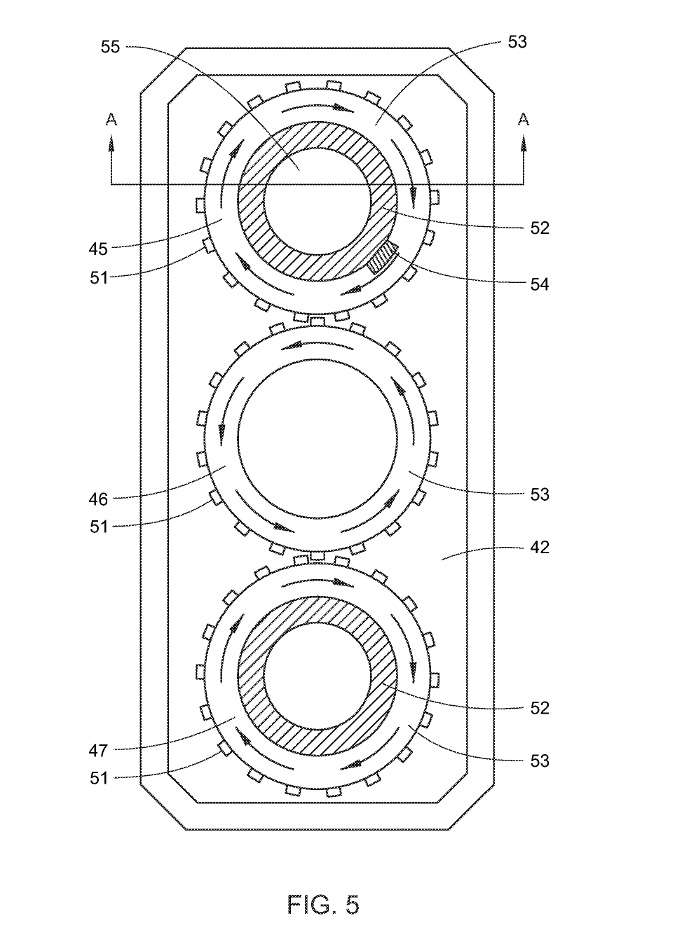

As shown in FIG. 2, the attachment assembly 5 includes a gear box 42 having at least two or more gears enclosed therein (two gears, 47 and 45, are shown), a hollow core drive shaft 14, a hollow core drill bit 16 having a hollow core bit coupler 15 thereon, and a mounting bracket 48 for securing a drill motor to the attachment assembly 5. The gear box 42 may have three gears enclosed therein (shown in FIG. 4), in which a standard drill motor having a substantially solid drive shaft therein 44 commonly used in core drilling is configured to threadably connect to a solid drive shaft gear 47, and a hollow core drive shaft 14 is configured to threadably connect to a hollow core drive shaft gear 45 (shown in FIG. 2). The third gear, i.e., an intermediary gear 46 is positioned adjacent to and in-between the solid drive shaft gear 47 and the hollow core drive shaft gear 45 (shown in FIGS. 4 and 5). The hollow core drive shaft 14 connects to a hollow core drive shaft drill bit coupler 15 located on the proximal end 19 of the hollow core drill bit 16 (shown in FIG. 2). As shown in FIGS. 2 and 3, the distal end 21 of the hollow core drill bit 16 may include a standard diamond tip cutting surface 17 commonly found on hollow core drill bits for in core drilling. An anchoring device 32 is positioned within the central axis of the hollow core drive shaft gear 45, the hollow core drive shaft 14, the hollow core drill bit coupler 15 and the hollow core drill bit 16 (shown in FIGS. 2-4), in which the proximal end 29 of the anchoring device 32 is secured to any suitable attachment (not shown) atop the slab 38 to be drilled to secure the anchoring device 32, and the distal end 31 of the anchoring device 32 is attached securely to a portion of a slab 38 to be severed at an attachment point 40 in order to secure that portion of the slab 38 from any substantial movement prior to, during or after a drilling operation, as well as to prevent release of the portion of the slab, i.e., core, from the interior of the hollow core drill bit 16 upon severance from surrounding slab 38.

As shown in FIG. 3, the gear box 42 is attached to a drill motor mounting bracket 48 reinforced by gussets 50 (shown in FIG. 4) which, in turn, is attached to the mounting carriage 24. The standard drill motor is attached to the drill motor mounting bracket 48 via a bracket attachment 49.

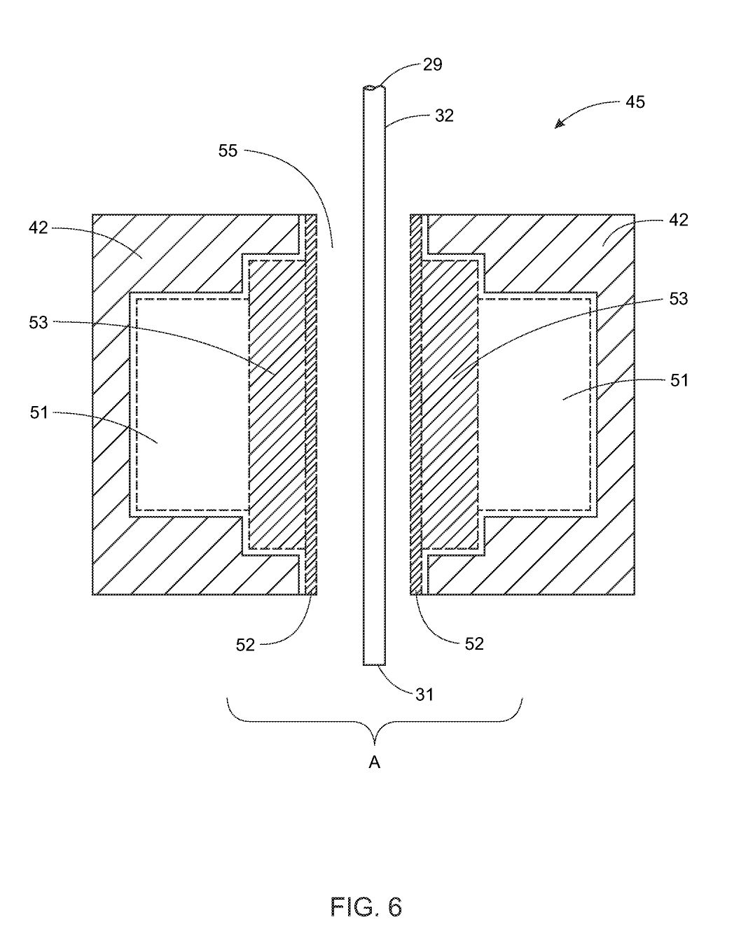

Referring now to FIGS. 4-6, three gears are shown: a solid drive shaft gear 47, an intermediary gear 46 and a hollow core drive shaft gear 45, enclosed in the gear box 42. The gear box 42 is attached to the drill motor mounting bracket 48 via gussets 50. Each gear includes a gear body 53 having a plurality of gear veins 51 thereon which interdigitate with gear veins 51 of an adjacent gear to sequentially transfer rotational movement from one gear to another. As shown in FIG. 5, clockwise rotation of the solid drive shaft gear 47 transfers rotational movement to the intermediary gear 46 to rotate in a counterclockwise direction, which transfers rotational movement to the hollow core drive shaft gear 45 to rotate in a clockwise direction. Alternatively, the solid drive shaft gear may rotate in a counterclockwise direction, thus changing the direction of rotation of the adjacent gears accordingly. The solid drive shaft gear 47 and the hollow core drive shaft gear 45 each have threads interior to the gear body 53 to couple to the threads on the solid drive shaft 44 and hollow core drive shaft 14, respectively. In addition, the hollow core drive shaft gear 45 contains a gear notch 54, or “key” on the gear threads 52, which is configured to attach to the hollow core drive shaft gear 45. The hollow core drive shaft gear 45 has an opening 55 in its interior space to accept the hollow core drive shaft 14 (shown in FIG. 2). Thus, rotation of the hollow core drive shaft gear 45, simultaneous and identical rotation of the hollow core drive shaft 14 occurs. The opening of the hollow core drive shaft 14 is configured to accept an independent anchoring device 32 therein (shown in FIG. 2). FIG. 6 is a cross-sectional view of the hollow core drive shaft gear 45 taken from points A-A in FIG. 5, showing (from the interior going outward) the center opening 55 to accept the anchoring device 32, the gear threads 52, the gear body 53, the gear veins 51, and the gear box 42.

Although FIGS. 4-6 show three gears 45, 46, 47 contained in the gear box 42, the invention encompasses an attachment assembly 5 having two gears, i.e., a solid drive shaft gear 47 adjacent to a hollow core drive shaft gear 45; three gears, i.e., an intermediary gear 46 positioned between the solid drive shaft gear 47 and the hollow core drive shaft gear 45; or four or more gears, i.e., two or more intermediary gears adjacent to one another and positioned between the solid drive shaft gear 47 and the hollow core drive shaft gear 45 (not shown).

In operation, best shown in FIG. 3, a standard solid drill motor 22 having a solid drive shaft 44 therein is attached via a bracket attachment 49 to the drill motor mounting bracket 48. The solid drive shaft 44 is threaded into the solid drive shaft gear 45 via threads on the surface of the solid drive shaft 44. A completely separate and independent anchoring device 32 is positioned through the central axis of the hollow core drive shaft gear 45, the hollow core drive shaft 14, the hollow core drill bit coupler 15, and the hollow core drill bit, extending below the distal end 21 of the hollow core drill bit 16. The proximal end 29 of the anchoring device 32 is secured to any suitable attachment (not shown) atop the slab 38 to be drilled to secure the anchoring device 32, and the distal end 31 of the anchoring device 32 is securely attached at an attachment point 40 to a portion of a slab 38 with any suitable means commonly known in the art, as described above. The solid drill motor 22 provides power to rotate blades located atop the solid drive shaft (not shown) atop the solid drive shaft to rotate the solid drive shaft 44. Rotation of the solid drive shaft 44 causes the solid drive shaft gear 47 to rotate. As shown in FIG. 5, rotation of the solid drive shaft gear 47 causes the intermediary gear 46 to rotate, which causes the hollow drive shaft gear 45 to rotate, which causes the hollow core drill bit 16 to rotate. During rotation, a user (e.g., drill operator) manually pushes the hollow core drill bit 16 into the surface of the slab 38 by turning the carriage travel gear 28 located on the mounting carriage 24. The mounting carriage 24 and the hollow core drive shaft device 10 attached thereto moves down the mounting post 20, causing the hollow core drill bit 16 to penetrate the slab 38 to form a severed core 18 (shown in FIG. 1) within the hollow core drill bit 16. The severed core 18 is prevented from falling out of the interior of the hollow core drill bit 16 via its attachment to the distal end 31 of the independent anchoring device 32.

Suitable materials for fabricating the hollow core drive shaft in accordance with the invention include, without limitation, metals, such as hardened steel, so long as the metal employed is strong enough to handle the degree of torque required to adequately rotate the hollow core drive shaft and hollow core drill bit.

The length of the hollow core drive shaft varies depending on the requirements of the core drilling project. In particular, the length of the hollow core drive shaft may range from between about 0.5 inches to about 36.0 inches, but lengths in excess of 36.0 inches are encompassed in the embodiments of the invention. In an embodiment, the length of the hollow core drive shaft is about 24 inches.

The diameter of the hollow core drive shaft similarly varies depending on the requirements of the project, i.e., the diameter of the core to be drilled is determined by the circumference of the opening needed in a substrate. In particular, the diameter of the hollow core drive shaft may range between about 0.5 inches to about 10.0 inches. In an embodiment, the diameter of the hollow core drive shaft is about 2.0 inches.

Any suitable anchoring device commonly used in the core drilling industry may be used in accordance with the invention, so long as it is physically isolated and independent from the hollow core drive shaft device of the invention. For example, suitable anchors may include, without limitation, rods that are through bolts or toggle bolts, rods that are “all threads,” i.e., rods which are threaded all the way through a threaded hollow drive shaft and threaded hollow core drill bit to penetrate a core, strong wires or chains, so long as they are small enough in diameter to fit within the openings of the hollow core drive shaft yet strong enough to secure a core within a hollow core bit after severance from surrounding slab.

Any suitable motor may be used in the drill motors of the invention. For example, and without limitation, motors such as electric motors, electromagnetic motors, hydraulic motors, pneumatic motors, combustion or compression-driven motors may be used. The drill motor of the invention may be powered directly, or power transferred indirectly, such as, without limitation, transferred from a gear transfer, a belt transfer, a hydraulic transfer, air transfer, or magnetic transfer.

It should be appreciated that the hollow core drive shaft device in accordance with the invention is structurally independent from the anchoring device positioned within the central axis of the hollow core drive shaft device. The core can be securely anchored 100% of the time and is fully accessible from the top side of a structure without the need to brace the underneath side of the structure from having the core fall down upon severance from the structure.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A hollow core drive shaft device for independently anchoring a core in a drilling operation, comprising:
a drill motor having a proximal end, a distal end and an interior space therein; said drill motor attached to a mounting carriage having a carriage travel gear thereon, said mounting carriage having an interior space therein defining an opening, said opening containing a mounting post having a gear rack thereon, said carriage travel gear engaged with the gear rack to move the mounting carriage on the mounting post;
a drill motor drive shaft having a proximal end, a distal end, and an interior space therein, said drill motor drive shaft contained within the drill motor, wherein the drill motor transfers power to the drill motor drive shaft in order to rotate the drill motor drive shaft;
a hollow core drill bit having a proximal end, a distal end and an interior space defining an opening therein, said proximal end having a hollow core bit coupler thereon, wherein rotation of the drill motor drive shaft is transferred to the hollow core drill bit to rotate the hollow core drill bit, wherein the hollow core drive shaft device allows for physical accessibility and visibility to a portion of a slab prior to, during, and after drilling of the portion of the slab by the distal end of the hollow core drill bit to form a core contained within the hollow core drill bit;
an anchoring device having a proximal end and a distal end, said anchoring device separate from and independent of the mounting carriage and mounting post contained therein, the drill motor, the drill motor drive shaft, and the hollow core drill bit, said anchoring device located at least within the opening of the hollow core drill bit and having its distal end attached to the core, wherein attachment of the anchoring device to the core prevents release of the core from the hollow core drill bit upon severance of the core from surrounding slab.

2. The hollow core drive shaft device of claim 1, wherein the interior space of the drill motor drive shaft defines an opening therein to form a hollow core drive shaft, said hollow core drive shaft threadably connected to the proximal end of the hollow core drill bit, and wherein the anchoring device is located within the opening of the hollow core drive shaft as well as within the hollow core drill bit.

3. The hollow core drive shaft device of claim 1, further comprising an attachment assembly comprised of a gear box containing at least two gears, a drive shaft having an interior space defining an opening therein to form a hollow core drive shaft, and a drill motor mounting bracket, wherein the first gear is a solid drive shaft gear and the second gear is a hollow core drive shaft gear, wherein the drill motor is attached to the mounting bracket, wherein the drill motor drive shaft contained in the drill motor threadably inserts into the solid drive shaft gear, wherein the hollow core drive shaft threadably inserts into the hollow core drive shaft gear, wherein the hollow core drive shaft connects to the hollow core bit coupler of the hollow core drill bit, wherein power from the drill motor rotates the drill motor drive shaft which rotates the solid drive shaft gear, which rotation is transferred to the hollow drive shaft gear to rotate the hollow core drill bit.

4. The hollow core drive shaft device of claim 3, wherein the solid drive shaft gear is adjacent to the hollow core drive shaft gear so that rotation of the solid drive shaft gear directly rotates the hollow drive shaft gear.

5. The hollow core drive shaft device of claim 3, wherein one or more intermediary gears are positioned between the solid drive shaft gear and the hollow core drive shaft gear so that rotation of the solid drive shaft gear is transferred to the hollow core drive shaft gear via rotation of the intermediary gears.

6. The hollow core drive shaft device of claim 3, wherein the solid drive shaft gear rotates in either a clockwise or a counterclockwise direction.

7. The hollow core drive shaft device of claim 3, wherein the length of the hollow core drive shaft ranges between about 0.5 inches to about 36.0 inches, and the diameter ranges between about 0.5 inches to about 10.0 inches.

8. The hollow core drive shaft device of claim 7, wherein the length of the hollow core drive shaft is about 24.0 inches, and the diameter is about 2.0 inches.

9. The hollow core drive shaft device of claim 1, wherein the anchoring device has a length ranging from about 0.5 foot to about 10.0 feet.

10. The hollow core drive shaft device of claim 1, wherein the anchoring device is a rod selected from the group consisting of an all-thread rod, a through-bolt and a toggle bolt.

11. A method of independently anchoring a core in a drilling operation, comprising:
placing an anchoring device through the openings of a hollow core drill motor, a hollow core drive shaft contained in the hollow core drill motor, a hollow core bit coupler, and a hollow core drill bit threadably connected to the hollow core bit coupler, said hollow core drill motor attached to a mounting carriage having a carriage travel gear thereon, said mounting carriage having an interior space therein defining an opening, said opening containing a mounting post having a gear rack thereon, said carriage travel gear engaged with the gear rack to move the mounting carriage on the mounting post;
attaching the anchoring device to a portion of a slab; and
drilling the portion of the slab with the hollow core drill bit in order to sever the portion of the slab from surrounding slab to form a core, said core contained within the hollow core drill bit, wherein the anchoring device is separate from and independent of the hollow core drill motor, the mounting carriage and mounting post contained therein, the hollow core drive shaft contained in the hollow core drill motor, the hollow core bit coupler, and the hollow core drill bit, and wherein no release of the core from within the hollow core drill bit occurs upon severance of the core from the surrounding slab.

12. The method of claim 11, wherein the length of the hollow core drive shaft ranges between about 0.5 inches to about 36.0 inches, and the diameter ranges between about 0.5 inches to about 10.0 inches.

13. The method of claim 12, wherein the length of the hollow core drive shaft is about 24.0 inches, and the diameter is about 2.0 inches.

14. The method of claim 11, wherein the anchoring device has a length ranging from about 0.5 foot to about 10.0 feet.

15. The method of claim 11, wherein the anchoring device is a rod selected from the group consisting of an all-thread rod, a through-bolt and a toggle bolt.

16. A method of independently anchoring a core in a drilling operation, comprising:
attaching a distal end of a drill motor drive shaft to an assembly attachment, said drill motor drive shaft contained within a drill motor, said drill motor attached to a mounting carriage having a carriage travel gear thereon, said mounting carriage having an interior space therein defining an opening, said opening containing a mounting post having a gear rack thereon, said carriage travel gear engaged with the gear rack to move the mounting carriage on the mounting post, said assembly attachment comprised of a gear box containing at least two gears, a hollow core drive shaft having an interior space defining an opening therein which threadably inserts into the hollow core drive shaft gear, a hollow core drill bit having a proximal end and a distal end and an interior space defining an opening therein, a hollow core bit coupler having an interior space defining an opening therein, said hollow core bit coupler integral to and adjacent to the proximal end of the hollow core drill bit, and a drill motor mounting bracket which attaches to the drill motor, wherein the at least two gears is a solid drive shaft gear and a hollow core drive shaft gear having an interior space defining an opening therein, wherein the drill motor drive shaft threadably inserts into the solid drive shaft gear, wherein the hollow core drive shaft threadably inserts into the hollow core drive shaft gear, wherein the hollow core drive shaft connects to the hollow core bit coupler of the hollow core drill bit, wherein power from the drill motor rotates the drill motor drive shaft which rotates the solid drive shaft gear, which rotation is transferred to the hollow core drive shaft gear to rotate the hollow core drill bit;
placing an anchoring device through the openings of the hollow core drive shaft gear, the hollow core drive shaft, the hollow core bit coupler and the hollow core drill bit;
attaching the anchoring device to a portion of a slab; and
drilling the portion of the slab with the hollow core drill bit in order to sever the portion of the slab from surrounding slab to form a core, said core contained within the hollow core drill bit, wherein the anchoring device is separate from and independent of the mounting carriage and mounting post contained therein, the hollow core drive shaft gear, the hollow core drive shaft, the hollow core drill bit coupler, and the hollow core drill bit, and wherein no release of the core from the hollow core drill bit occurs when the core is severed from the surrounding slab.

17. The method of claim 16, wherein the solid drive shaft gear is adjacent to the hollow core drive shaft gear so that rotation of the solid drive shaft gear directly rotates the hollow drive shaft gear.

18. The method of claim 16, wherein one or more intermediary gears are positioned between the solid drive shaft gear and the hollow core drive shaft gear, wherein rotation of the solid drive shaft gear is transferred to the hollow core drive shaft gear via rotation of the one or more intermediary gears.

19. The method of claim 16, wherein the solid drive shaft gear rotates in either a clockwise or a counterclockwise direction.

20. The method of claim 16, wherein the length of the hollow core drive shaft ranges between about 0.5 inches to about 36.0 inches, and the diameter ranges between about 0.5 inches to about 10.0 inches.

21. The method of claim 20, wherein the length of the hollow core drive shaft is about 24.0 inches, and the diameter is about 2.0 inches.

22. The method of claim 16, wherein the anchoring device has a length ranging from about 0.5 foot to about 10.0 feet.

23. The method of claim 16, wherein the anchoring device is a rod selected from the group consisting of an all-thread rod, a through-bolt and a toggle bolt.
